(19) United States
(12) Patent Application Publication
(10) Pub. No.: US 2021/0382208 A1
(43) Pub. Date: Dec. 9, 2021

(54) MULTI-FUNCTION DIFFUSION FILM AND DIFFUSION PLATE CONTAINING THE SAME

(71) Applicant: Wah Hong Industrial Crop., Kaohsiung (TW)

(72) Inventors: Chih-Chen WU, Kaohsiung (TW); Ying-Ming WU, Kaohsiung (TW); Chung-En CHENG, Kaohsiung (TW)

(21) Appl. No.: 17/207,004

(22) Filed: Mar. 19, 2021

(30) Foreign Application Priority Data
Jun. 5, 2020 (TW) 109118946

(51) Int. Cl. G02B 5/02; C08K 3/22; C08F 2/50; C08F 2/20; C08F 26/06; C08K 5/37; C08J 5/18

(52) U.S. Cl. CPC G02B 5/0226; G02B 5/0268; C08K 3/22; C08F 2/50; C08F 2/20; C08F 26/06; B82Y 20/00; C08J 5/18; G02B 2207/101; G02B 2207/113; C08K 2003/2241; C08K 2003/2296; C08J 2339/04; C08K 5/37

(57) ABSTRACT

A diffusion film is provided, including a matrix material including a reaction product of following components: a polythiol, a polyolefin, and a crosslinking agent having thiol and alkenyl functional groups; a photoluminescence material including at least a quantum dot or at least a fluorescent powder; and light diffusion particles including organic polymer particles and/or inorganic particles.

### CROSS-REFERENCE TO RELATED APPLICATIONS

The present application claims priority of Taiwan Application No. 109118946, filed on Jun. 5, 2020, which is incorporated by reference herein in its entirety.

### BACKGROUND

### Technical Field

The disclosure relates to an optical film, and more particularly to a diffusion film and a diffusion plate containing the same.

### Description of the Related Art

An optical film is a film that obtains the desired optical properties by changing its light transmission characteristics, such as transmission, reflection, absorption, scattering, polarization, spectrum, and phase changes. At present, optical films can be found in almost any kind of optical instrument or optoelectronic device. In recent years, due to developments in flat panel displays, the demand for optical films has increased significantly, and the optical films have gradually become multi-tasking.

In general, an optical film may include a diffusion film, a prism film (also known as a brightness enhancement film), a light guide plate (LGP), a reflector, etc. It can make the scattered light be uniformly transmitted to the entire panel to eliminate uneven light or cover up some optical defects, such as moire traces of uneven brightness. It can also direct the light to the viewer at a proper angle of vision, and increase the brightness of the light source through the microstructure, and reflect the light to increase the efficiency of the light source. Furthermore, it can use fluorescent luminescent materials or quantum dot materials to increase color saturation or increase brightness to improve energy efficiency.

With the development of display and/or lighting technology, in order to meet the needs of various devices, high-efficiency multi-functional diffusion films have become a new developing main stream.

### SUMMARY

Some embodiments of the present disclosure provide a diffusion film including a matrix material including a reaction product of the following components: a polythiol, a polyolefin, and a crosslinking agent having thiol and alkenyl functional groups; a photoluminescence material including at least a quantum dot or at least a fluorescent powder; and light diffusion particles including organic polymer particles and/or inorganic particles.

In some embodiments, the quantum dot includes CdSe, CdZnSe, ZnCdS, CdSeS/ZnS, ZnCdSeS, InP, CuInSe₂, CuInS₂, AgInS₂, ZnTe, CsPbCl₃, CsPbBr₃, CsPbI₃, or a combination thereof.

In some embodiments, the fluorescent powder includes ZnS, CdS, SrS, CaS, Sr₂P₂O₇, (CaZn)₃(PO₄)₂, Zn₂SiO₄, CaSiO₃, MgWO₄, CaWO₄, BaMg₂Al₁₆O₂₇, CeMgAl₁₁O₁₉, Sr₄Al₁₄O₂₅, K₂SiF₆:Mn₄⁺, Y₂O₃, La₂O₃, or a combination thereof.

In some embodiments, the polythiol is represented by the following formula: R¹(SH)ₓ, wherein R¹ is a hydrocarbyl group or hetero-hydrocarbyl group having a valence of x, and x≥2.

In some embodiments, R¹ of the polythiol is an aliphatic group or an aromatic group, and includes ester, amide, ether, urethane, thioether, urea functional groups, or a combination thereof.

In some embodiments, R¹ of the polythiol is an aliphatic group, a cyclic aliphatic group, an aromatic group, or an alkyl-substituted aromatic group, wherein R¹ includes 1 to 20 carbon atoms and 1 to 4 heteroatoms of oxygen, nitrogen, or sulfur.

In some embodiments, the polyolefin is represented by the following formula:

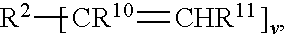

wherein R² is a multi-valent hydrocarbyl group or hetero-hydrocarbyl group, R¹⁰ and R¹¹ are independently a hydrogen atom or an alkyl group having 1 to 4 carbon atoms, and y≥2.

In some embodiments, R² of the polyolefin is an aliphatic group, a cyclic aliphatic group or an aromatic group, and includes ester, amide, ether, urethane, thioether, urea functional groups, or a combination thereof.

In some embodiments, a thiol molar equivalent of the polythiol and the crosslinking agent is equal to an alkenyl molar equivalent of the polyolefin and the crosslinking agent.

In some embodiments, the crosslinking agent includes at least one of the following structures:

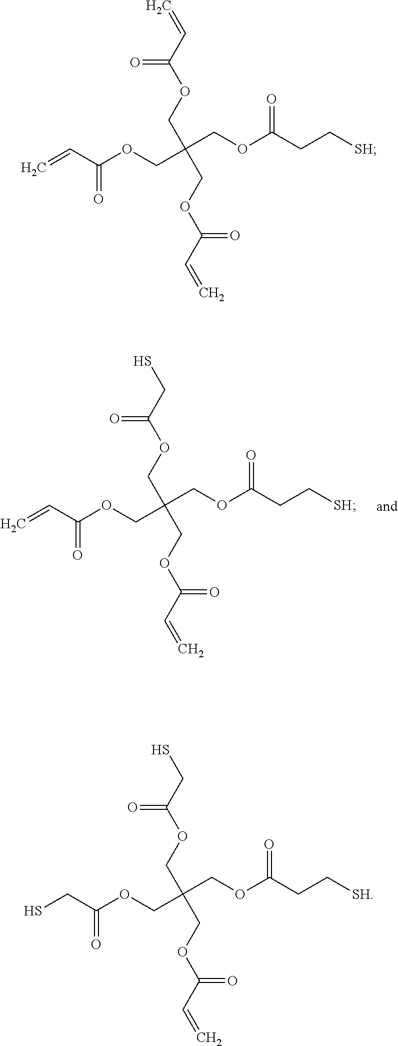 [SMILES: C=CC(=O)OCC(COC(=O)C=C)(COC(=O)C=C)COC(=O)CCS ; C=CC(=O)OCC(COC(=O)C=C)(COC(=O)CS)COC(=O)CCS ; C=CC(=O)OCC(COC(=O)CS)(COC(=O)CS)COC(=O)CCS]

In some embodiments, the organic polymer particles include polystyrene polymer, polymethyl methacrylate polymer, acrolein-based cross-linked polymer, acrolein-styrene cross-linked polymer, benzomelamine-formaldehyde polymer, melamine-formaldehyde condensation polymer, benzomelamine-melamine-formaldehyde condensation polymer, or a combination thereof.

In some embodiments, the inorganic particles include SiO₂, TiO₂, ZnO, SrSO₄, BaSO₄, or a combination thereof.

Other embodiments of the present disclosure provide a diffusion plate, including: a pair of diffusion films, each including the diffusion film as described above; and a substrate disposed between the pair of diffusion films.

In other embodiments, the substrate includes: glass, a release film, a polymer film, a metal coating, a multilayer film, or a combination thereof.

### BRIEF DESCRIPTION OF THE DRAWINGS

Aspects of this disclosure are best understood from the following detailed description when read with the accompanying figures. It should be noted that, in accordance with common practice in the industry, various features are not drawn to scale. In fact, the dimensions of the various features may be arbitrarily increased or reduced for clarity of discussion.

FIG. 1 illustrates a cross-sectional view of a diffusion plate according to some embodiments of the present disclosure.

FIG. 2 illustrates a cross-sectional view of a diffusion plate according to other embodiments of the present disclosure.

### DETAILED DESCRIPTION

The following disclosure provides many different embodiments, or examples, for implementing different features of the subject matter provided. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features. Some variations of embodiments are described below. In different figures and illustrated embodiments, similar element symbols are used to indicate similar elements. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “overlapped,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Furthermore, when a number or a range of numbers is described with “about,” “approximate,” and the like, the term is intended to encompass numbers that are within a reasonable range including the number described, such as within +/−10% of the number described or other values as understood by person skilled in the art. For example, the term “about 5 nm” encompasses the dimension range from 4.5 nm to 5.5 nm.

As used herein, “aliphatic group” refers to saturated mono-valent hydrocarbons which can be straight, branched, cyclic, or non-cyclic.

As used herein, “alkenyl” refers to unsaturated hydrocarbons which can be straight or branched.

As used herein, “aryl” refers to mono-valent aromatic groups, such as phenyl, naphthyl, etc.

As used herein, “hetero-hydrocarbyl” includes hetero-hydrocarbyl hetero-alkyl and hetero-hydrocarbyl hetero-aryl. The hetero-hydrocarbyl hetero-alkyl and hetero-hydrocarbyl hetero-aryl include one or more hetero atoms, such as ether or amino group in the chain. Hetero-hydrocarbyl includes one or more functional groups in the chain, and the functional group includes ester functional group, amide functional group, urea functional group, carbamate functional group and carbonate functional group.

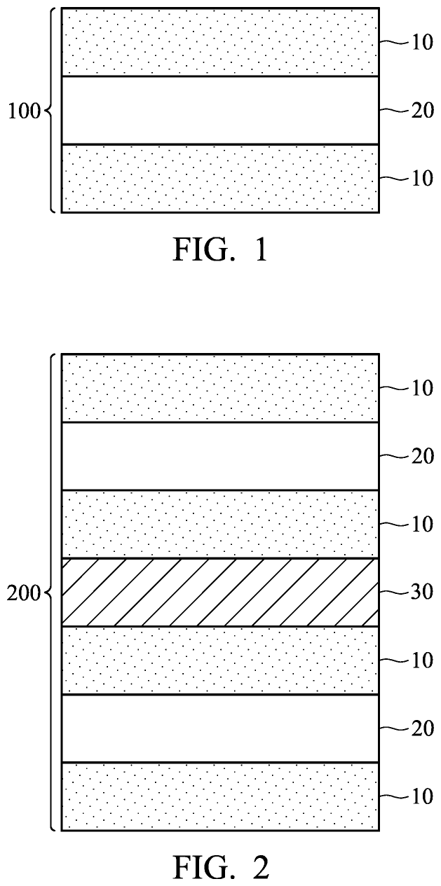

Referring to FIG. 1, embodiments of the disclosure provide a diffusion film 10. The diffusion film 10 includes a matrix material (A), a photoluminescence material (B), and light diffusion particles (C). The matrix material includes a reaction product of the following components: a polythiol (a1), a polyolefin (a2), and a crosslinking agent (a3) having thiol and alkenyl functional groups. By adding the crosslinking agent (a3) having thiol and alkenyl functional groups, it can be crosslinked with both of polythiol (a1) and polyolefin (a2), thereby enhancing the luminance of the diffusion film 10. Furthermore, by adding the light diffusion particles (C), the haze value is reduced due to increased scattering, and the uniformity of light after passing through the diffusion film 10 can be improved. The main components of the diffusion film of some embodiments of the present disclosure will be described sequentially hereafter.

In some embodiments, the polythiol (a1) may include compounds represented in the following Formula 1.

R¹(SH)ₓ Formula 1

R¹ is a hydrocarbyl group or hetero-hydrocarbyl group having a valence of x, and x≥2. Specifically, R¹ may be an aliphatic group, a cyclic aliphatic group, an aromatic group, or an alkyl-substituted aromatic group and include ester, amide, ether, urethane, thioether, urea functional groups, or a combination thereof. R¹ may include 1 to 20 carbon atoms and 1 to 4 heteroatoms of oxygen, nitrogen or sulfur.

For example, the polythiol (a1) may include compounds as shown in the following Formula 1A, 1B or 1C.

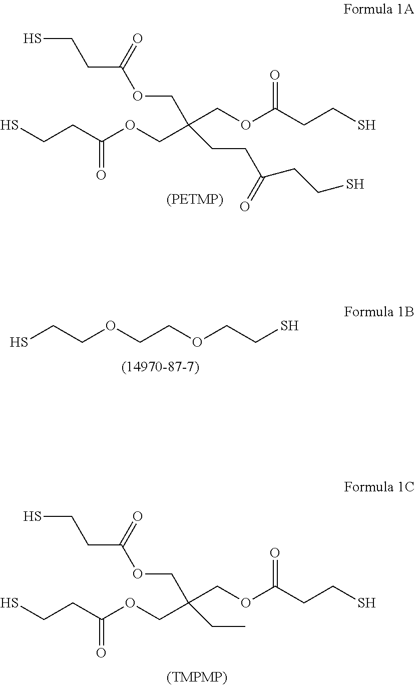 [SMILES: O=C(CCS)CCC(COC(=O)CCS)(COC(=O)CCS)COC(=O)CCS ; "(PETMP)" ; SCCOCCOCCS ; CCC(COC(=O)CCS)(COC(=O)CCS)COC(=O)CCS ; "(TMPMP)"]

In some embodiments, the polythiol (a1) may be 5 wt % to 50 wt % of the matrix material (A), for example, 25 wt % to 38 wt %.

In some embodiments, the polyolefin (a2) may include compounds represented in the following Formula 2.

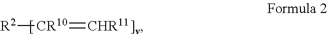

R² is a multi-valent hydrocarbyl group or hetero-hydrocarbyl group, and y≥2. Specifically, R² may be an aliphatic group, a cyclic aliphatic group, or an aromatic group and include ester, amide, ether, urethane, thioether, urea functional groups, or a combination thereof. R¹⁰ and R¹¹ may be independently a hydrogen atom or an alkyl group having 1 to 4 carbon atoms.

For example, the polyolefin (a2) may include compounds as shown in the following Formula 2A or 2B.

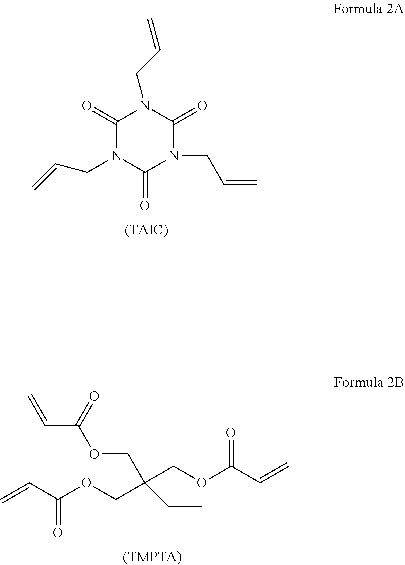

In some embodiments, the polyolefin (a2) may be 5 wt % to 40 wt % of the matrix material (A), for example, 20 wt % to 30 wt %.

In some embodiments, the crosslinking agent (a3) having thiol and alkenyl functional groups may include compounds as shown in the following Formula 3A, 3B or 3C.

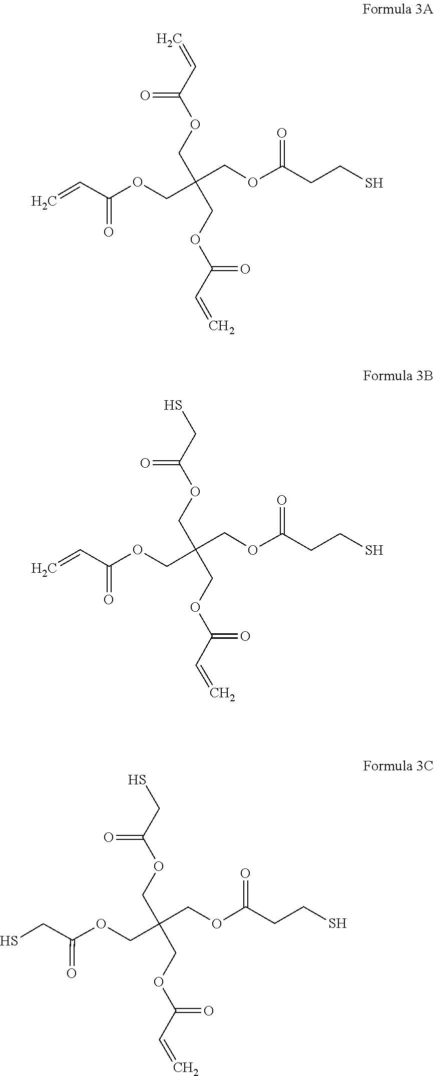 [SMILES: C=CC(=O)OCC(COC(=O)C=C)(COC(=O)C=C)COC(=O)CCS ; C=CC(=O)OCC(COC(=O)C=C)(COC(=O)CS)COC(=O)CCS ; C=CC(=O)OCC(COC(=O)CS)(COC(=O)CS)COC(=O)CCS]

Compared with a crosslinking agent having only a single thiol or a single alkenyl functional group, the crosslinking agent (a3) having thiol and alkenyl functional groups according to embodiments of the present disclosure can be crosslinked with the polythiol (a1) as well as the polyolefin (a2). Multifunctional thiol with alkenyl not only has lower odor than general thiol but also has more sites to form free radicals when illuminated. That is, the molar equivalent amount of reaction is higher than those of general crosslinking agents so that the reaction rate and the degree of crosslinking are better than those with only a single thiol or alkenyl functional group.

In some embodiments, the crosslinking agent (a3) having thiol and alkenyl functional groups may be 3 wt % to 30 wt % of the matrix material (A), for example, 10 wt % to 22 wt %.

In some embodiments, in the matrix material (A), a thiol molar equivalent of the polythiol (a1) and the crosslinking agent (a3) is equal to an alkenyl molar equivalent of the polyolefin (a2) and the crosslinking agent (a3).

In some embodiments, the photoluminescence material (B) may include quantum dots or fluorescent powder. The photoluminescence material (B) can be used to adjust or convert the light color.

In some embodiments, the quantum dots may include AgInS₂ (AIS), CuInS₂ (CIS), CdSe, CdS, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSe, CdZnSeTe, CdZnSTe, CdHgSeS, CdHgSeTe, CdHgSTe, CdHgSTe, HgZnSeS, HgZnSeTe, HgZnSTe, GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, ANSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, Si, Ge, SiC, SiGe, ZnMnSe, GaAsP, AlGaInP, AlGaInN, GaP:N, CsPbCl₃, CsPbBr₃, CsPbI₃, or a combination thereof.

In some embodiments, the fluorescent powder may include sulfide fluorescent powder, such as zinc sulfide (ZnS), cadmium sulfide (CdS), strontium sulfide (SrS), calcium sulfide (CaS); halophosphate fluorescent powder, such as calcium halophosphate; phosphate fluorescent powder, such as strontium phosphate (Sr₂P₂O₇), barium phosphate (Ba₂P₂O₇), calcium zinc phosphate [(Ca, Zn)₃(PO₄)₂]; silicate fluorescent powder, such as zinc silicate (Zn₂SiO₄), calcium silicate (CaSiO₃); tungstate fluorescent powder, such as magnesium tungstate (MgWO₄), calcium tungstate (CaWO₄); aluminate fluorescent powder, such as barium magnesium aluminate (BaMg₂Al₁₆O₂₇), cerium magnesium aluminate (CeMgAl₁₁O₁₉), strontium aluminate (Sr₄Al₁₄O₂₅); fluoride fluorescent powder, such as potassium fluorosilicate (K₂SiF₆:Mn₄⁺); oxide fluorescent powder, such as yttrium oxide (Y₂O₃) or lanthanum oxide (La₂O₃).

In some embodiments, the photoluminescence material (B) may be 1 wt % to 35 wt % of the diffusion film 10, for example, 20 wt % to 33 wt %.

In some embodiments, the light diffusion particles (C) include organic polymer particles and/or inorganic particles. In some embodiments, the light diffusion particles (C) can uniformly distribute light, increase the scattering of primary light with the photoluminescence materials, and prevent sticking.

In some embodiments, the organic polymer particles may include polystyrene polymer, polymethyl methacrylate polymer, acrolein-based cross-linked polymer, acrolein-styrene cross-linked polymer, benzomelamine-formaldehyde polymer, melamine-formaldehyde condensation polymer, benzomelamine-melamine-formaldehyde condensation polymer, or a combination thereof.

In some embodiments, the inorganic particles may include SiO₂, TiO₂, ZnO, SrSO₄, BaSO₄, or a combination thereof.

In some embodiments, the light diffusion particles (C) may be 1 wt % to 35 wt % of the diffusion film 10, for example, 18 wt % to 33 wt %.

In some embodiments, in addition to the above components, the diffusion film of the present disclosure may further include dispersants, surfactants, polymerization initiation aids, fillers, adhesion promoters, antioxidants, light stabilizers and/or other suitable additives. It should be noted that it is not intended to limiting herein.

Other embodiments of the present disclosure provide a diffusion plate 100. The diffusion films 10 of anyone of embodiments described above are formed on upper and lower sides of a substrate 20, as shown in FIG. 1. In some embodiments, the substrate 20 may include glass, a release film, a polymer film, a metal coating, a multilayer film, or a combination thereof. In some embodiments, the substrate 20 may include glass, silicone release film, fluorine release film, cyclic olefin copolymer (COC), polyimide (PI), polyethylene terephthalate (PET), polyethylene (PE), polypropylene (PP), polycarbonate (PC), copper film, or aluminum film, etc.

In some embodiments, the thickness of the substrate 20 may be between about 12 μm and about 125 μm. For example, between about 25 μm and about 100 μm.

The diffusion film 10 may be formed on the upper and lower sides of the substrate 20 by any suitable method. In some embodiments, the diffusion film 10 may be formed by coating or printing and followed by curing. In some embodiments, coating methods that may be used to form the diffusion film 10 include, for example, die coating, blade coating, roller coating, and dip coating or spray coating. In some embodiments, printing methods that may be used to form the diffusion film 10 include, for example, screen printing, flexography printing (FLEXO), gravure printing, relief printing or planographic printing. In some embodiments, curing methods that may be used to form the diffusion film 10 include, for example, UV curing or thermal curing. For example, a UV light source may be used, and the exposure amount may be 250-500 mJ/cm², such as 290-365 mJ/cm² for exposure, or a thermal curing may be used at temperature of 50° C. to 150° C. continued for about 10 seconds to 10 minutes.

If the thickness of the diffusion film 10 is too thick, problems such as uneven thickness and poor optical effect may easily occur in the manufacturing process. If the thickness of the diffusion film 10 is too thin, the desired optical effect may not be achieved. Therefore, in some embodiments, the diffusion film 10 may be a single-layer or multi-layer structure to achieve the desired thickness. In some embodiments, the thickness of the diffusion film 10 may be about 2 μm to 120 μm, for example, about 5 μm to 100 μm.

Yet other embodiments of the present disclosure provide a diffusion plate 200. The diffusion plate 200 is formed by adhering the diffusion plate 100 of anyone of embodiments described above through a transparent optical adhesive 30. The transparent optical adhesive 30 is disposed between two layers of the diffusion plates, as shown in FIG. 2.

Several examples and comparative examples are provided below to specifically describe the effects of the diffusion film of the present disclosure.

### Example 1

41.5 wt % of polythiol (PETMP, Bruno Bock Chemische), 26.5 wt % of polyolefin (TAIC, Evonik Industries), 6.06 wt % of crosslinking agent as shown in Formula 3A (Zhenjiang Hexuan Biochem Tech Co., Ltd.), 1.2 wt % of photoinitiator (Irgacure® 819), 10 wt % of dispersant such as modified phenolic resin, and quantum dot (CFQD® Quantum Dots, Nanoco Technologies Ltd) solution were used to formulate a coating material. In the resulting coating material, the thiol molar equivalent was equal to the alkenyl molar equivalent. Then, at room temperature and in a lithography area, the coating material described above was formed on opposite sides of the polymer film such as PET film by blade coating or screen printing. The thickness of the coating material was controlled between 70 μm and 120 μm, and the coating material was subsequently cured with UV light (500 mJ/cm²) to form the film, thus a diffusion plate was provided.

### Example 2

40.6 wt % of polythiol (PETMP), 21.2 wt % of polyolefin (TAIC), and 10.1 wt % of crosslinking agent as shown in Formula 3A were used to formulate a coating material. The photoinitiator, dispersant, quantum dot solution, and film-forming method were the same as in Example 1. In the resulting coating material, the thiol molar equivalent was equal to the alkenyl molar equivalent.

### Example 3

38.5 wt % of polythiol (PETMP), 20.4 wt % of polyolefin (TAIC), and 20.2 wt % of crosslinking agent as shown in Formula 3A were used to formulate a coating material. The photoinitiator, dispersant, quantum dot solution, and film-forming method were the same as in Example 1. In the resulting coating material, the thiol molar equivalent was equal to the alkenyl molar equivalent.

### Example 4

30.9 wt % of polythiol as shown in Formula 1B (14970-87-7, Tokyo Chemical Industry Co., Ltd.), 26.5 wt % of polyolefin (TAIC), and 6.06 wt % of crosslinking agent as shown in Formula 3A were used to formulate a coating material. The photoinitiator, dispersant, quantum dot solution, and film-forming method were the same as in Example 1. In the resulting coating material, the thiol molar equivalent was equal to the alkenyl molar equivalent.

### Example 5

33.8 wt % of polythiol (TMPMP, Bruno Bock Chemische), 26.5 wt % of polyolefin (TAIC), and 6.06 wt % of crosslinking agent as shown in Formula 3A were used to formulate a coating material. The photoinitiator, dispersant, quantum dot solution, and film-forming method were the same as in Example 1. In the resulting coating material, the thiol molar equivalent was equal to the alkenyl molar equivalent.

### Example 6

40.6 wt % of polythiol (PETMP), 29.4 wt % of polyolefin (TMPTA, Double Bond Chemical Ind. Co., Ltd), and 10.1 wt % of crosslinking agent as shown in Formula 3A were used to formulate a coating material. The photoinitiator, dispersant, quantum dot solution, and film-forming method were the same as in Example 1. In the resulting coating material, the thiol molar equivalent was equal to the alkenyl molar equivalent.

### Example 7

28.7 wt % of polythiol (14970-87-7), 24.2 wt % of polyolefin (TMPTA), and 20.2 wt % of crosslinking agent as shown in Formula 3A were used to formulate a coating material. The photoinitiator, dispersant, quantum dot solution, and film-forming method were the same as in Example 1. In the resulting coating material, the thiol molar equivalent was equal to the alkenyl molar equivalent.

### Example 8

41.5 wt % of polythiol (PETMP), 26.5 wt % of polyolefin (TAIC), and 6.06 wt % of crosslinking agent as shown in Formula 3A were used to formulate a coating material. In the resulting coating material, the thiol molar equivalent was equal to the alkenyl molar equivalent. The photoinitiator, dispersant, quantum dot solution, and film-forming method were the same as in Example 1. In Example 8, a “sandwich structure” was formed by adhering a pair of diffusion plates with a transparent optical adhesive. The transparent optical adhesive was disposed between the pair of diffusion plates.

### Example 9

30.9 wt % of polythiol as shown in Formula 1B (14970-87-7, Tokyo Chemical Industry Co., Ltd.), 26.5 wt % of polyolefin (TAIC), and 6.06 wt % of crosslinking agent as shown in Formula 3A were used to formulate a coating material. In the resulting coating material, the thiol molar equivalent was equal to the alkenyl molar equivalent. The photoinitiator, dispersant, quantum dot solution, and film-forming method were the same as in Example 1. In Example 9, a “sandwich structure” was formed by adhering a pair of diffusion plates with a transparent optical adhesive. The transparent optical adhesive was disposed between the pair of diffusion plates.

### Example 10

33.8 wt % of polythiol (TMPMP, Bruno Bock Chemische), 26.5 wt % of polyolefin (TAIC), and 6.06 wt % of crosslinking agent as shown in Formula 3A were used to formulate a coating material. In the resulting coating material, the thiol molar equivalent was equal to the alkenyl molar equivalent. The photoinitiator, dispersant, quantum dot solution, and film-forming method were the same as in Example 1. In Example 10, a “sandwich structure” was formed by adhering a pair of diffusion plates with a transparent optical adhesive. The transparent optical adhesive was disposed between the pair of diffusion plates.

### Example 11

The polythiol, polyolefin, crosslinking agent, photoinitiator, dispersant, quantum dot solution, and film-forming method were the same as in Example 1. In the resulting coating material, the thiol molar equivalent was equal to the alkenyl molar equivalent. 5 wt % of light diffusion particles (TiO₂) were additionally added in the coating material.

### Example 12

The polythiol, polyolefin, crosslinking agent, photoinitiator, dispersant, quantum dot solution, and film-forming method were the same as in Example 1. In the resulting coating material, the thiol molar equivalent was equal to the alkenyl molar equivalent. 5 wt % of light diffusion particles (ZnO, Sakai Trading Co., Ltd.) were additionally added in the coating material.

### Example 13

The polythiol, polyolefin, crosslinking agent, photoinitiator, dispersant, quantum dot solution, and film-forming method were the same as in Example 1. In the resulting coating material, the thiol molar equivalent was equal to the alkenyl molar equivalent. 5 wt % of light diffusion particles (MBX-8, Sekisui Plastics) were additionally added in the coating material.

### Example 14

The polythiol, polyolefin, crosslinking agent, photoinitiator, dispersant, quantum dot solution, and film-forming method were the same as in Example 1. In the resulting coating material, the thiol molar equivalent was equal to the alkenyl molar equivalent. 5 wt % of light diffusion particles (EPOSTAR™-MS, Nippon Shokubai) were additionally added in the coating material.

### Example 15

The polythiol, polyolefin, crosslinking agent, photoinitiator, dispersant, quantum dot solution, and film-forming method were the same as in Example 1. In the resulting coating material, the thiol molar equivalent was equal to the alkenyl molar equivalent. 5 wt % of light diffusion particles (ZnO) were additionally added in the coating material.

### Example 16

16 wt % of quantum dot solution was used. The rest of polythiol, polyolefin, crosslinking agent, photoinitiator, dispersant, and film-forming method were the same as in Example 12. In the resulting coating material, the thiol molar equivalent was equal to the alkenyl molar equivalent.

### Example 17

18 wt % of quantum dot solution was used. The rest of polythiol, polyolefin, crosslinking agent, photoinitiator, dispersant, and film-forming method were the same as in Example 12. In the resulting coating material, the thiol molar equivalent was equal to the alkenyl molar equivalent.

### Comparative Example 1

42.8 wt % of polythiol (PETMP) and 29.1 wt % of polyolefin (TAIC) were used to formulate a coating material. The photoinitiator, dispersant, quantum dot solution, and film-forming method were the same as in Example 1 except that a crosslinking agent was not added in the coating material. In the resulting coating material, the thiol molar equivalent was equal to the alkenyl molar equivalent.

### Comparative Example 2

31.9 wt % of polythiol (14970-87-7) and 29.1 wt % of polyolefin (TAIC) were used to formulate a coating material. The photoinitiator, dispersant, quantum dot solution, and film-forming method were the same as in Example 1 except that a crosslinking agent was not added in the coating material. In the resulting coating material, the thiol molar equivalent was equal to the alkenyl molar equivalent.

### Comparative Example 3

34.8 wt % of polythiol (TMPMP) and 29.1 wt % of polyolefin (TAIC) were used to formulate a coating material. The photoinitiator, dispersant, quantum dot solution, and film-forming method were the same as in Example 1 except that a crosslinking agent was not added in the coating material. In the resulting coating material, the thiol molar equivalent was equal to the alkenyl molar equivalent.

### Comparative Example 4

42.8 wt % of polythiol (PETMP) and 34.6 wt % of polyolefin (TMPTA) were used to formulate a coating material. The photoinitiator, dispersant, quantum dot solution, and film-forming method were the same as in Example 1 except that a crosslinking agent was not added in the coating material. In the resulting coating material, the thiol molar equivalent was equal to the alkenyl molar equivalent.

### Comparative Example 5

31.9 wt % of polythiol (14970-87-7) and 34.6 wt % of polyolefin (TMPTA) were used to formulate a coating material. The photoinitiator, dispersant, quantum dot solution, and film-forming method were the same as in Example 1 except that a crosslinking agent was not added in the coating material. In the resulting coating material, the thiol molar equivalent was equal to the alkenyl molar equivalent.

The component ratios and measurement results of luminance of Examples 1-7 and Comparative Examples 1-5 are shown in Table 1. The component ratios and measurement results of luminance and haze value of Examples 1 and 9-14 are shown in Table 2.

In the present disclosure, a backlight unit (BLU) was used to measure the luminance of the examples and comparative examples. The backlight unit has a blue LED with a peak wavelength of 450 nm to stimulate illumination and measure the performance of the film. The diffusion plates formed in the examples and the comparative examples were formed into a multi-layer composite film through a transparent optical adhesive which was then disposed between the light guide plate and the backlight unit. Next, the backlight unit was utilized to measure the luminance of the light-exiting surface through a spectroradiometer (GL Spectis 1.0 and GL optiprobe detector).

The NDH 5000 W haze meter was used to measure the haze value, and the JIS K7105 or ASTM D1003 specification was used for measurement.

TABLE 1

| | | | | | | | cross- | | | | quantum | | |
|---|---|---|---|---|---|---|---|---|---|---|---|---|---|
| | | | molar | | | molar | linking | molar | photo- | | dot | | |
| | | | equiv- | poly- | | equiv- | agent | equiv- | initiator | dispersant | solution | | relative |
| | polythiol | wt % | alent | olefin | wt % | alent | (wt %) | alent | (wt %) | (wt %) | (wt %) | luminance | luminance |
| Example 1 | PETMP | 41.5 | 0.97 | TAIC | 26.5 | 0.91 | 6.06 | 0.03 | 1.2 | 10.0 | 14.0 | 8361.4 | 1.12 |
| Example 2 | PETMP | 40.6 | 0.95 | TAIC | 21.2 | 0.85 | 10.1 | 0.05 | 1.2 | 10.0 | 14.0 | 8436.0 | 1.13 |
| Example 3 | PETMP | 38.5 | 0.9 | TAIC | 20.4 | 0.7 | 20.2 | 0.1 | 1.2 | 10.0 | 14.0 | 8510.7 | 1.14 |
| Example 4 | 14970-87-7 | 30.9 | 0.97 | TAIC | 26.5 | 0.91 | 6.06 | 0.03 | 1.2 | 10.0 | 14.0 | 8062.8 | 1.08 |
| Example 5 | TMPMP | 33.8 | 0.97 | TAIC | 26.5 | 0.91 | 6.06 | 0.03 | 1.2 | 10.0 | 14.0 | 8510.7 | 1.14 |
| Example 6 | PETMP | 40.6 | 0.95 | TMPTA | 29.4 | 0.85 | 10.1 | 0.05 | 1.2 | 10.0 | 14.0 | 8286.7 | 1.11 |
| Example 7 | 14970-87-7 | 28.7 | 0.9 | TMPTA | 24.2 | 0.7 | 20.2 | 0.1 | 1.2 | 10.0 | 14.0 | 8137.4 | 1.09 |
| Example8 | PETMP | 41.5 | 0.97 | TAIC | 26.5 | 0.91 | 6.06 | 0.03 | 1.2 | 10.0 | 14.0 | 9488.5 | 1.27 |
| Example9 | 14970-87-7 | 30.9 | 0.97 | TAIC | 26.5 | 0.91 | 6.06 | 0.03 | 1.2 | 10.0 | 14.0 | 9264.4 | 1.24 |
| Example10 | TMPMP | 33.8 | 0.97 | TAIC | 26.5 | 0.91 | 6.06 | 0.03 | 1.2 | 10.0 | 14.0 | 9712.7 | 1.30 |
| Comparative | PETMP | 42.8 | 1 | TAIC | 29.1 | 1 | 0 | 0 | 1.2 | 10.0 | 14.0 | 7471.3 | 1.00 |
| Example 1 | | | | | | | | | | | | | |
| Comparative | 14970-87-7 | 31.9 | 1 | TAIC | 29.1 | 1 | 0 | 0 | 1.2 | 10.0 | 14.0 | 7366.0 | 0.99 |
| Example 2 | | | | | | | | | | | | | |
| Comparative | TMPMP | 34.8 | 1 | TAIC | 29.1 | 1 | 0 | 0 | 1.2 | 10.0 | 14.0 | 7524.0 | 1.01 |
| Example 3 | | | | | | | | | | | | | |
| Comparative | PETMP | 42.8 | 1 | TMPTA | 34.6 | 1 | 0 | 0 | 1.2 | 10.0 | 14.0 | 7426.2 | 0.99 |
| Example 4 | | | | | | | | | | | | | |
| Comparative | 14970-87-7 | 31.9 | 1 | TMPTA | 34.6 | 1 | 0 | 0 | 1.2 | 10.0 | 14.0 | 7335.9 | 0.98 |
| Example 5 | | | | | | | | | | | | | |

TABLE 2

| | | | | | | | cross- | | | | quantum | light | | |
|---|---|---|---|---|---|---|---|---|---|---|---|---|---|---|
| | | | molar | | | molar | linking | molar | photo- | | dot | diffusion | | |
| | | | equiv- | poly- | | equiv- | agent | equiv- | initiator | dispersant | solution | particle | | |
| | polythiol | wt % | alent | olefin | wt % | alent | (wt %) | alent | (wt %) | (wt %) | (wt %) | (5 wt %) | haze | luminance |
| Example 1 | PETMP | 41.5 | 0.97 | TAIC | 26.5 | 0.91 | 6.06 | 0.03 | 1.2 | 10.0 | 14.0 | — | 84.23 | 8361.4 |
| Example 11 | PETMP | 41.5 | 0.97 | TAIC | 26.5 | 0.91 | 6.06 | 0.03 | 1.2 | 10.0 | 14.0 | TiO₂ | 58.93 | 7339.9 |
| Example 12 | PETMP | 41.5 | 0.97 | TAIC | 26.5 | 0.91 | 6.06 | 0.03 | 1.2 | 10.0 | 14.0 | ZnO | 63.31 | 7526.5 |
| Example 13 | PETMP | 41.5 | 0.97 | TAIC | 26.5 | 0.91 | 6.06 | 0.03 | 1.2 | 10.0 | 14.0 | MBX-8 | 72.06 | 7624.8 |
| Example 14 | PETMP | 41.5 | 0.97 | TAIC | 26.5 | 0.91 | 6.06 | 0.03 | 1.2 | 10.0 | 14.0 | MS | 60.61 | 7426.8 |
| Example 15 | TMPMP | 41.5 | 0.97 | TAIC | 26.5 | 0.91 | 6.06 | 0.03 | 1.2 | 10.0 | 14.0 | ZnO | 62.92 | 7546.5 |
| Example 16 | TMPMP | 41.5 | 0.97 | TAIC | 26.5 | 0.91 | 6.06 | 0.03 | 1.2 | 10.0 | 16 | ZnO | 63.22 | 7981.3 |
| Example 17 | TMPMP | 41.5 | 0.97 | TAIC | 26.5 | 0.91 | 6.06 | 0.03 | 1.2 | 10.0 | 18 | ZnO | 63.52 | 8426.2 |

As shown in Table 1, compared to Comparative Example 1, Examples 1-3 have higher luminance. As the amount of the crosslinking agent increases, the luminance tends to enhance. Comparative Examples 2, 3, 4 and 5 correspond to Examples 4, 5, 6 and 7 respectively. Examples 4-7 also have higher luminance. According to the results shown in Table 1, it illustrates that the addition of the crosslinking agent can enhance the luminance. According to Examples 8-10, compared to the single diffusion plate, the luminance is significantly improved when the diffusion plate is formed into the sandwich structure.

As shown in Table 2, compared to Example 1 where no light diffusion particles were added, Examples 11-14 including light diffusing particles had lower haze values so that the uniformity of light after passing through the diffusion film can be improved.

Still referring to Table 2, in Examples 15-17, Example 17 has the maximum amount of quantum dot solution, Example 15 has the minimum amount of quantum dot solution, and Example 16 has an amount of quantum dot solution that is between Example 15 and Example 17. According to Examples 15-17, it illustrates that increasing the amount of the quantum dot solution can enhance the luminance.

Embodiments of the present disclosure have some advantageous features. Compared to conventional diffusion films, the diffusion film with the crosslinking agent of the present disclosure may have a higher luminance. Furthermore, the diffusion film including the light diffusion particles of the present disclosure may reduce the haze value to improve the uniformity of light after passing through the diffusion film.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A diffusion film, comprising:
(a) a matrix material comprising a reaction product of following components:
(a1) a polythiol;
(a2) a polyolefin; and
(a3) a crosslinking agent having thiol and alkenyl functional groups;
(b) a photoluminescence material comprising at least a quantum dot or at least a fluorescent powder; and
(c) light diffusion particles comprising organic polymer particles and/or inorganic particles.

2. The diffusion film as claimed in claim 1, wherein the quantum dot comprises CdSe, CdZnSe, ZnCdS, CdSeS/ZnS, ZnCdSeS, InP, CuInSe₂, CuInS₂, AgInS₂, ZnTe, CsPbCl₃, CsPbBr₃, CsPbI₃, or a combination thereof.

3. The diffusion film as claimed in claim 1, wherein the fluorescent powder comprises ZnS, CdS, SrS, CaS, Sr₂P₂O₇, (CaZn)₃(PO₄)₂, Zn₂SiO₄, CaSiO₃, MgWO₄, CaWO₄, BaMg₂Al₁₆O₂₇, CeMgAl₁₁O₁₉, Sr₄Al₁₄O₂₅, K₂SiF₆:Mn₄⁺, Y₂O₃, La₂O₃, or a combination thereof.

4. The diffusion film as claimed in claim 1, wherein the polythiol is represented by the following formula:
R¹(SH)ₓ, wherein R¹ is a hydrocarbyl group or hetero-hydrocarbyl group having a valence of x, and x≥2.

5. The diffusion film as claimed in claim 4, wherein R¹ of the polythiol is an aliphatic group or an aromatic group, and comprises ester, amide, ether, urethane, thioether, urea functional groups, or a combination thereof.

6. The diffusion film as claimed in claim 4, wherein R¹ of the polythiol is an aliphatic group, a cyclic aliphatic group, an aromatic group, or an alkyl-substituted aromatic group, wherein R¹ comprises 1 to 20 carbon atoms and 1 to 4 heteroatoms of oxygen, nitrogen, or sulfur.

7. The diffusion film as claimed in claim 1, wherein the polyolefin is represented by the following formula: 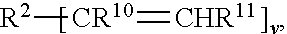
wherein R² is a multi-valent hydrocarbyl group or hetero-hydrocarbyl group, R¹⁰ and R¹¹ are independently a hydrogen atom or an alkyl group having 1 to 4 carbon atoms, and y≥2.

8. The diffusion film as claimed in claim 7, wherein R² of the polyolefin is an aliphatic group, a cyclic aliphatic group or an aromatic group, and comprises ester, amide, ether, urethane, thioether, urea functional groups, or a combination thereof.

9. The diffusion film as claimed in claim 1, wherein a thiol molar equivalent of the polythiol and the crosslinking agent is equal to an alkenyl molar equivalent of the polyolefin and the crosslinking agent.

10. The diffusion film as claimed in claim 1, wherein the crosslinking agent comprises at least one of following structures:

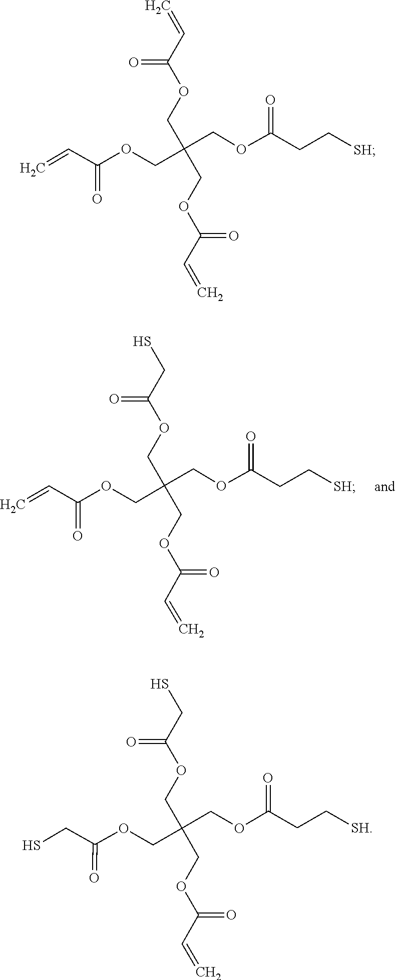

11. The diffusion film as claimed in claim 1, wherein the organic polymer particles comprise: polystyrene polymer, polymethyl methacrylate polymer, acrolein-based cross-linked polymer, acrolein-styrene cross-linked polymer, benzomelamine-formaldehyde polymer, melamine-formaldehyde condensation polymer, benzomelamine-melamine-formaldehyde condensation polymer, or a combination thereof.

12. The diffusion film as claimed in claim 1, wherein the inorganic particles comprise: SiO₂, TiO₂, ZnO, SrSO₄, BaSO₄, or a combination thereof.

13. A diffusion plate, comprising:
A pair of diffusion films, each comprising the diffusion film as claimed in claim 1; and
a substrate disposed between the pair of diffusion films.

14. The diffusion plate as claimed in claim 13, wherein the substrate comprises: glass, a release film, a polymer film, a metal coating, a multilayer film, or a combination thereof.
